(19) United States
(12) Patent Application Publication
(10) Pub. No.: US 2006/0134450 A1
(43) Pub. Date: Jun. 22, 2006

(54) Additives for improved weldable composites

(76) Inventors: David R. Sigler, Shelby Township, MI (US); Xiaohong Q. Gayden, West Bloomfield, MI (US); Yen-Lung Chen, Troy, MI (US); James G. Schroth, Troy, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/017,419

(22) Filed: Dec. 20, 2004

(51) Int. Cl. B32B 15/06; B23K 11/10

(52) U.S. Cl. 428/621; 428/624; 428/625; 219/91.21

(57) ABSTRACT

The present invention is directed to additives for improved weldable composites. A metal composite structure (10) features two metal members (12) (14) sandwiching a viscoelastic layer (26) where the viscoelastic layer entrains carbide-forming, carbon trapping particles (28) that provide an effective inhibitor to carbon migration from the viscoelastic layer during welding.

### I. BACKGROUND OF THE INVENTION

1. Field of the Invention

The present invention relates to metal composites. More particularly, the present invention relates to a sound damping metal composite which is resistance spot weldable.

2. Discussion of the Related Art

Metal composites are used to reduce noise and vibration in a wide range of applications. These applications include automobiles or other vehicles, machinery, appliances, power equipment and the like. These metal composites include a viscoelastic layer located between two metal structures, typically in sheet form. To allow for resistance spot welding, the viscoelastic layer has conductive particles distributed therein that facilitate electrical conduction through the composite during the welding process.

Several issues are encountered when the metal composites are resistance spot welded to other metal composites or solid steel panels. During the welding process, conductive particles near the welding electrode melt due to a combination of current flow through the particles and heat generated at the weld zone. In addition, discrete portions of the viscoelastic layer decompose in the region of the weld resulting in both carbon generation and high gas pressure. Tests have shown that the liquid produced from the melting particles, particularly if rich in iron or nickel, will react with the carbon from the decomposed viscoelastic layer. In the case of welding ferrous-based substrates, this carbon enriched liquid attacks and promotes carbon diffusion at the boundaries of the metal substrates, which degrades weld quality at the weld site from selectively localized melting and thinning as well as the formation of hard carbon-rich areas. When in sheet form or relatively thinner areas, the metallurgical and physical deterioration of the composite often result in the formation of blistering or blow holes. An additional problem occurs in the case of welding carbide-forming substrates, such as titanium alloys. Carbon from the decomposed viscoelastic layer reacts with the substrate forming carbide that negatively impacts weld quality.

### II. SUMMARY OF THE INVENTION

It is, therefore, an object of the present invention to address and overcome problems of the prior art

Another object of this invention is to provide an improved weldable composite and method for its formation.

A further object of the invention is to provide a weldable composite that minimizes metallurgical and physical carbon-induced damage by incorporating carbon trap particles.

Still another object of this invention is to provide a composite that possesses substantial weld quality, is relatively light weight, and provides sound/vibration damping.

A further object of the invention is to provide a weldable composite incorporating a carbon attractant to reduce undesirable carbide formation in carbide-forming alloy substrates such as titanium alloys.

A final stated, but only one of additional numerous objects of the invention, is to provide a weldable, sound damping composite incorporating carbon attractant particles that consolidate carbon and reduce contaminant migration directly to adjacent metal members and indirectly through melted conductive particles from a sandwiched viscoelastic material.

These and other objects are satisfied by a weldable metal composite, comprising, a first metal member and a second metal member, a viscoelastic layer disposed between said first and second metal members, said viscoelastic layer including carbon trapping additives where said additives inhibit migration of carbon containing moieties from the viscoelastic layer to both the metal member and melted conductive particles during welding of the composite and in the event that carbon is picked up by the melted conductive particles, the additives inhibit migration of carbon from the melted particles to the metal member.

The foregoing and other objects are satisfied by a method comprising the steps of making a sound damping metal composite for welding, comprising the steps of:

selecting a first metal member formed of a metal selected from the group consisting of low carbon steel, interstitial free steel, bake hardenable steel, high-strength low-alloy steel, transformation induced plasticity, martensitic, dual-phase steel, stainless steel, titanium, titanium alloy, and alloys susceptible to carbide formation;

selecting a second metal member formed of a metal selected from the group consisting of low carbon steel, interstitial free steel, bake hardenable steel, high-strength low-alloy steel, transformation induced plasticity, martensitic, dual-phase steel, stainless steel, titanium, titanium alloy, and alloys susceptible to carbide formation; and

applying a viscoelastic layer between said first metal member and said second metal member, said layer including carbon trapping additives where during welding of the composite said additives 1) inhibit migration of carbon containing moieties from the viscoelastic layer to both the metal members and melted conductive particles and 2) in the event that carbon is picked up by the melted conductive particles, inhibit migration of carbon from the melted particles to the metal member.

The metal composite of the present invention overcomes the limitations of the prior art as briefly described above, by providing particulated additives to the viscoelastic layer which, during the welding process, effectively retard carbon diffusion and/or migration by establishing a carbon trap to inhibit carbon diffusion and/or migration into the metal substrates. These reactive additives inhibit carbon-induced damage such as melting and formation of hard carbon rich areas in ferrous-based alloys and melting and/or excessive carbide formation in carbide-forming alloys such as titanium alloys.

An aspect of the present invention is directed to a metal composite comprising a metal member having at least a first surface, and a metal article having at least a first juxtaposed surface. The metal member and metal article permit an electric current to flow there between during welding of the composite. A viscoelastic layer incorporating reactive additives is located between the first surface of the metal substrate and the first juxtaposed surface of the metal article. During welding of the composite, at least some of the reactive particles form a first reactive diffusion boundary associated with the first surface of the metal substrate, and form a second reactive diffusion boundary associated with the first juxtaposed surface of the metal article. The first and second reactive boundaries react with carbon generated within the viscoelastic layer, and thereby inhibit and/or prevent carbon diffusion and/or migration from the viscoelastic adhesive layer into the metal substrate and metal article during welding of the composite. In one embodiment of the invention the boundary is in the form of a discrete layer established by the reactive particles. In another embodiment of the invention, the reactive particles provide a sufficient carbon trap, without physical disposition or migration during welding to inhibit diffusion and/or migration of carbon into the metal substrate and metal article.

In one embodiment of the invention, the viscoelastic layer is a pressure sensitive adhesive and may include conductive particles to facilitate electric current flow between the metal substrate and the metal article during welding. The conductive particles may be composed of a material selected from the group consisting of iron, nickel, copper, aluminum and electrically conductive alloys and compounds thereof. The reactive particles may be composed of a material selected from the group consisting of chromium, titanium, niobium, silicon, zirconium, and vanadium or alloys and compounds thereof. Preferably, the reactive particles have a melting point between about 500° C. and about 2000° C. In addition, the reactive particles establish a carbon trap for reacting with carbon in the adhesive layer during welding of the composite to preferably form carbide and thereby provide an effective boundary against migration of the carbon into the adjacent metal elements as well as reduce the level of carbon in the gaseous decomposition products.

Another aspect of the present invention is directed to a method of making a metal composite including applying a viscoelastic layer incorporating reactive carbon-trapping particles between an interior surface of a metal substrate and a juxtaposed surface of a metal article. During welding of the composite, at least some of the trapping reactive particles establish a boundary against migration of carbon to prevent migration into the adjacent metal members. The reactive particles exhibit a propensity for carbide formation with a resulting preference for absorption of carbon released in the viscoelastic layer. Consequently, the particles retard carbon diffusion and/or migration into the adjacent metal members and melted conductive particles during welding of the composite. The resulting metal composite is sound damping and typically has a total thickness between about 0.30 mm and about 3.00 mm.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, and which is shown by way of illustration to the specific embodiments in which the invention may be practiced. The following embodiments are described in sufficient detail to enable those skilled in the art to practice the invention. It is to be understood that other embodiments may be utilized and that structural changes based on presently known structural and/or functional equivalents may be made without departing from the scope of the invention. Given the following description, it should become apparent to the person having ordinary skill in the art that the invention herein provides a lightweight laminated, sound/vibration damping composite and method providing significantly augmented efficiencies while mitigating problems of the prior art.

The accompanying figure shows an illustrative embodiment of the invention from which these and other of the objectives, novel features and advantages will be readily apparent.

### III. BRIEF DESCRIPTION OF THE DRAWING

FIG. 1 is a cross-sectional view of a metal composite made in accordance with the present invention.

### IV. DETAILED DESCRIPTION OF THE PREFERRED EMBODIMENTS

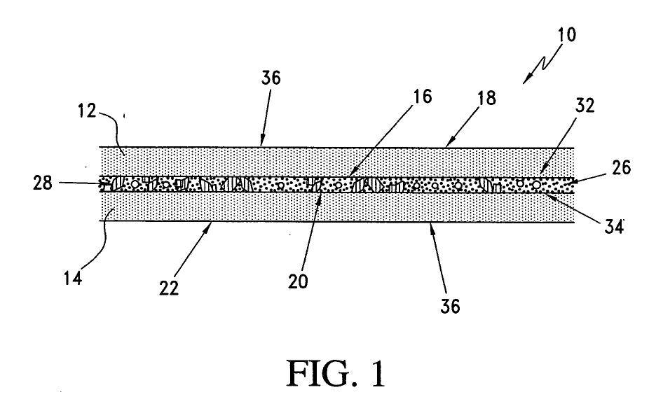

Referring to FIG. 1, shown is a metal composite 10 comprising a metal sheet 12 and a metal article 14. The metal article 14 may be any shape, including but not limited to a sheet; a longitudinal member including a tube, such as a hydroformed tube or a rail, such as a rail section in an automobile. In a preferred embodiment, the metal article 14 is a metal sheet as illustrated in FIG. 1. The metal sheet 12 includes an interior surface 16 and an exterior surface 18. Similarly, the metal article 14 has a first surface 20 and a second surface 22. The first surface 20 of the metal article 14 may be an interior surface, and the second surface 22 of the metal article may be an exterior surface. The metal sheet 12 and metal article 14 may be comprised of any metal suitable for welding, including but not limited to steel or titanium alloys. Preferably, the metal sheet 12 and metal article 14 are comprised of steel, including but not limited to low carbon, interstitial free, bake hardenable, high strength low alloy, transformation induced plasticity (TRIP), martensitic, dual phase, or stainless steel.

A viscoelastic layer 26 is located between the interior surface 16 of the metal sheet 12 and the first surface 20 of the metal article 14. The viscoelastic layer 26 may be comprised of any adhesive known to those having skill in the art which is effective in bonding the metal sheet 12 and the metal article 14 together. The layer 26, is preferably a viscoelastic resin such as a pressure sensitive adhesive, including but not limited to a poly(isoprene:styrene) copolymer or a poly alkyl acrylate. Preferably, the pressure sensitive adhesive is comprised of a poly(isoprene:styrene) copolymer. The adhesive layer typically has a thickness between about 0.005 mm and about 0.200 mm. Preferably, the adhesive layer is between about 0.02 mm and about 0.05 mm thick.

Conductive particles 28 may be located between the interior surface 16 of the metal sheet 12 and the first surface 20 of the metal article 14. The conductive particles 28 allow an electric current to initially flow between the metal sheet 12 and the metal article 14 during welding of the metal sheet and metal article. The conductive particles 28 are typically located within the adhesive layer 26. As the composite 10 is welded, the metal sheet 12 and the metal article 14 are forced closer together which causes the area or gap between the interior surface 16 of the metal sheet and the first surface 20 of the metal article to decrease. Each conductive particle 28 is sized to alone, or in combination with at least one additional conductive particle, to bridge the area between the interior surface 16 of the metal sheet 12 and the first surface 20 of the metal article 14 during welding of the composite 10. Alternatively, agglomerates of smaller sized conductive particles 28 are sized to bridge the gap between the metal sheet 12 and the metal article 14. The conductive particles 28 may be comprised of any material which allows electricity to flow between the metal sheet 12 and the metal article 14 during welding. Suitable materials include, but are not limited to pure metals such as iron, nickel, copper, aluminum, or any electrically conductive alloys or compounds thereof, including iron phosphide. Preferably, the conductive particles 28 are comprised of nickel.

The viscoelastic layer 26 incorporates reactive particles 30. During welding of the composite 10, at least some of the reactive particles 30 disposed under the welding electrode melt, and establish a carbon trap that, when molten, under hydraulic pressure, may spread to form a discrete reactive boundary (illustrated as boundary 32) located on the interior surface 16 of the metal sheet 12. A corresponding boundary 34 may form adjacent to the first surface 20 of the metal article 14. Each of the boundaries 32 and 34 may assume the form of a continuous layer, a discontinuous layer, or may be admixed through the viscoelastic layer 26. In the region of the weld, the reactive boundaries 32 and 34 typically assume the form of a discontinuous layer. The reactive boundaries 32 and 34 and any remaining reactive particles 30 in the vicinity of the weld possess a preference for elemental carbon and gaseous organics by reacting with such moieties to preferably form carbides. This reaction removes the moieties and prevents and/or inhibits the diffusion and/or migration of carbon from the layer 26 into the adjacent metal elements or melted conductive particles during welding.

The reactive particles 30 preferably have a lower melting point than the metal sheet 12 and the metal article 14, thereby providing intermixed boundaries and even forming reactive boundaries 32 and 34 during the welding process prior to melting of the metal sheet and metal article. Preferably, the reactive particles 30 have a melting point between about 500° C. and 2000° C. More, preferably, the reactive particles 30 have a melting point between about 1000° C. and about 1500° C.

The reactive particles 30 are composed of any suitable material which exhibits a preference for binding with organic decomposition products and elemental carbon from the viscoelastic layer 26 to prevent and/or inhibit diffusion and/or migration of carbon therefrom directly into the metal sheet 12 and metal article 14 or indirectly through the molten conductive particles during welding of the composite 10. The reactive particles 30 may be comprised of carbide forming elements including, but not limited to chromium, titanium, niobium, silicon, zirconium, and vanadium or alloys or compounds thereof such as iron-silicon or iron-titanium alloys. Preferably, the reactive particles are comprised of chromium or titanium.

When formed of metals or alloys or compounds of reasonable conductivity, the reactive particles 30 exhibit electrical conduction properties and therefore, may also function as the conductive particles 28, without the need for additional materials in the composite 10.

The composite 10 may include a coating 36 located on the exterior surface 18 of the metal sheet 12 and the second surface 22 of the metal article 14. The coating 36 may be comprised of any material known to those having skill in the art which is capable of preventing and/or inhibiting corrosion or rusting of the metal sheet 12 and metal article 14. Preferably, the coating 36 is a galvanized coating for ferrous substrates.

Welding the composite 10 of the present invention may include welding the metal sheet 12 to the metal article 14, or it may include welding the entire composite to another structure or material. The composite 10 of the present invention is suitable for various types of welding including, but not limited to drawn arc welding and resistance welding including resistance spot welding and projection welding.

The composite 10 of the present invention possesses sound damping and vibration damping qualities. When in sheet form, as illustrated in FIG. 1, the composite 10 typically has a thickness between about 0.30 mm and about 3.00 mm and preferably, has a total thickness between about 0.6 mm and about 1.5 mm. When in a substantially sheet-like form, the composite 10 is useful for numerous sound damping applications including, but not limited to use in automobiles or other vehicles, machinery, business equipment, appliances and power equipment. For example, the composite 10 may be used in the plenum, front of dash or floorpan of an automobile.

The present invention is also directed to a method of making a composite 10 described above. By way of example, in the illustrated sheet form, the method includes the step of applying a viscoelastic layer 26 between the juxtaposed interior surface 16 of a metal sheet 12 and the first surface 20 of a metal article 14. The viscoelastic layer 26 preferably is a pressure sensitive adhesive that may be applied by any method known to those having skill in art, including but not limited to extrusion, roll coating, or spray coating. As described above, the layer 26 entrains reactive particles 30 some of which, during welding, melt and redistribute within the composite to establish carbon anti-migration boundaries. The boundaries exhibit a thermodynamic preference for organic moieties formed during welding reacting therewith to establish effective carbon anti-migration boundaries and carbon traps within the composite. Thus, practice of the invention minimizes damage to the metal composite resulting from carbon migration from decomposition of the viscoelastic of the composite 10.

Specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A weldable metal composite, comprising:
a first metal member and a second metal member;
a viscoelastic layer disposed between said first and second metal members, said viscoelastic layer including carbon trapping additives where said additives inhibit carbon pick up and migration of carbon containing moieties from the viscoelastic layer to the metal member during welding of the composite.

2. The metal composite according to claim 1 where during welding said carbon trapping additive establishes at least one carbide-forming boundary between said viscoelastic layer and said metal members.

3. The metal composite according to claim 2 where the carbon trapping additive is selected from the group consisting of chromium, titanium, niobium, silicon, zirconium, vanadium, iron-silicon alloys or compounds, iron-titanium alloys or compounds, and alloys and admixtures thereof.

4. The metal composite according to claim 2 where the carbon trapping additive is selected from the group consisting of chromium or titanium.

5. The metal composite according to claim 1 where said viscoelastic layer is a pressure sensitive adhesive having electrically conductive particles dispersed therethrough and where the composite exhibits sound damping properties.

6. The metal composite according to claim 5 where said pressure sensitive adhesive is selected from the group consisting of poly(isoprene:styrene), copolymers, terpolymers, thereof, and poly (alkyl acrylate), copolymers, terpolymers, etc.

7. The metal composite according to claim 2 where the boundary forms within the viscoelastic layer to a thickness of between 0.0005 mm to about 0.02 mm.

8. The metal composite according to claim 7 where the deposited carbon trapping additive is in the form of particles so dispersed to form a continuous barrier on said viscoelastic layer having a thickness from about 0.002 mm to about 0.010 mm.

9. The metal composite according to claim 6 further comprising conductive particles of a material selected from the group consisting of iron, nickel, copper, aluminum, and electrically conductive alloys and compounds thereof.

10. The metal composite according to claim 2, wherein said first metal member and said second metal member are composed of a material selected from the group consisting of steel, titanium alloy, and carbide-forming alloys.

11. The metal composite of claim 10, wherein the reactive particles are comprised of chromium or titanium.

12. The metal composite of claim 11, wherein the reactive particles have a melting point between about 500° C. and 2000° C.

13. The metal composite of claim 12, wherein the reactive particles define a discontinuous layer.

14. The metal composite of claim 12, wherein the reactive particles define a continuous layer.

15. The metal composite of claim 14, wherein the first and second metal members possess a substantially sheet-like form and are a titanium alloy.

16. The metal composite of claim 14, wherein first and second metal members possess a substantially sheet-like form and comprises steel selected from the group consisting of low carbon, interstitial free, bake hardenable, high strength low alloy, transformation induced plasticity, martensitic, dual phase, and stainless steel.

17. A weldable metal composite, comprising:
a first metal member and a second metal member;
a viscoelastic layer disposed between said first and second metal members, said viscoelastic layer including conductive particles that melt during welding and carbon trapping additives where said additives inhibit carbon pick up and migration of carbon containing moieties.

18. A method of making a sound damping metal composite for welding, comprising the steps of:
selecting a first metal member formed of a metal selected from the group consisting of low carbon steel, interstitial free steel, bake hardenable steel, high-strength low-alloy steel, transformation induced plasticity, martensitic, dual-phase steel, stainless steel, titanium, titanium alloy, and alloys susceptible to carbide formation;
selecting a second metal member formed of a metal selected from the group consisting of low carbon steel, interstitial free steel, bake hardenable steel, high-strength low-alloy steel, transformation induced plasticity, martensitic, dual-phase steel, stainless steel, titanium, titanium alloy, and alloys susceptible to carbide formation; and
applying a viscoelastic layer between said first metal member and said second metal member, said layer including carbon trapping additives where said additives inhibit migration of carbon containing moieties from the viscoelastic layer to the metal members during welding of the composite.

19. The method of claim 18, further comprising the step of:
dispersing conductive particles within the viscoelastic layer.

20. The method of claim 19 further comprising the step of
resistance spot welding the composite where reactive particles melt and react with carbon to form carbides and to thereby inhibit carbon diffusion from the viscoelastic into the metal members.
